(19) United States
(12) Patent Application Publication
(10) Pub. No.: US 2003/0213343 A1
(43) Pub. Date: Nov. 20, 2003

(54) Rotary insert bits and hand tools

(76) Inventor: Paul Scott Schuster, Racine, WI (US)

Correspondence Address: Paul Scott Schuster, 5245 Oak Forest Drive, Racine, WI, 53406, US

(21) Appl. No.: 10/151,065

(22) Filed: May 18, 2002

(51) Int. Cl. B25B 13/00

(52) U.S. Cl. 81/73

(57) ABSTRACT

A efficient hand tool and insert bit design to provide uninterrupted continuous rotation when driving rotary fasteners in very low to moderately high torque situations, and allows seamless transition to normal tightening methods when fastening torque increases beyond this range, all with the use of one hand. In addition, invention allows user to apply more turning torque towards the fastener then normal screwdriver type hand tools.

### BACKGROUND

1. Field of Invention

The present invention relates to hand rotary tools such as screwdrivers, bit-drivers, nut-drivers, ratcheting screwdrivers and bit drivers, and square and hex drive tools which are used for the manual turning of many different types of rotary fasteners. Such tools operate in a intermittent fashion, having the operator either grip and re-grip or twist the tool back and forth as with ratcheting screwdrivers to drive threaded fasteners. Additionally it relates to crank handle screwdrivers providing continuous rotation with leverage type tightening.

This invention and its embodiments bridge the gap between these two schools of drivers, providing the best of both worlds in seamless transition, to give an operator a unique, efficient, one hand operated rotary driver.

2. Description of Prior Art

There are many different types of screwdrivers today to aid the operator in turning the many different styles and sizes of rotary fasteners. However, most require rotation of the operators wrist to perform the fastening task. Crank style drivers have also been developed, but use levered tightening torque or two handed operation. Some examples of the different types of screwdrivers to aid the operator in fastening are shown in the following U.S. patents:

U.S. Pat. No. 4,974,477 to Anderson discloses a speed wrench crank handle screwdriver for high speed rotation of threaded fasteners. A similar device is shown in Des 396,623. These tools are not traditional functioning screwdrivers because the handles are mounted with full rotation with respect to their s-curve shaped shafts. A ball bearing is used between the handle and the shaft to allow force towards the fastener to be applied without damage to the handles, retaining smooth rotation of handle. The tools function by rotating them about the fastener with rotation of the wrist, pivoting at the wrist. Great effort has been made in the design of these tools to provide superior handle rotation with respect to the shaft. The design is clumsy to use when tightening fasteners due to the requirement of the free spinning handle to facilitate its use, not allowing torque to be applied by twisting the handle as in traditional drivers. Tightening is accomplished by levering the tool's handle, which best requires a two-handed method. One hand levering the handle, and the other hand holding the tool shank in line with the fastener because the lever force is working to tip the shank from alignment. Additionally, when using the tools with one hand, limited tightening torque can be applied with rotation of the wrist verses the traditional method of twisting the driver handle to apply high torque.

U.S. Pat. No. 5,349,886 to Jin discloses two embodiments, one embodiment having a shiftable z-shaped shank with a spring loaded handle. The shank is shifted from a detented or locked position to a rotary position by pulling back the handle against a spring, pivoted to align position two, and pushed back into the second position, requiring the use of two hands. No mechanical information is disclosed on how the detented position functions with an offset shank like a conventional screw driver. This tool requires an awkward two handed manual shifting process of the handle to facilitate its use, and would build fatigue in the operator when constantly shifting the handle back and forth to install multiple fasteners in succession.

Jin discloses a second embodiment showing two rotating handles mounted to the z-shaped shank, having a inner bearing surfaces to slide against the shank surface. The second handle is designed with specific clearance to be tilted and thus produce a low friction bind with the shank such that ease is encountered when engaging the tool's tip with a fastener, by lightly holding the otherwise loose tool shank. This may be useful is some cases, however gravity alone acting on the shank can position it in a repeatable downward position for easy fastener engagement.

U.S. Pat. No. 2,712,765 to Knight discloses two embodiments, one embodiment having a pistol-grip handle and a crank arm s-shaped shaft rotatably mounted to the handle. The mount further employs a spring loaded toothed clutch assembly that shifts the handle from free rotation with the shaft to a locked up state upon force towards the fastener. A detented clutch locking assembly with actuating member is used to prevent clutch lock up when hard driving force is required towards the fastener. With the clutch engaged, this tool uses a lever type torque produced by the pistol-grip about the fastener to provide high tightening torque. In order to apply such torque, the clutch mechanism (i.e. handle) must be constantly pushed towards the fastener to ensure the locked state.

Knight discloses a second embodiment showing ratcheting socket wrench with a jointed or folding handle. The gripable portion of the handle is mounted with a rotatable sleeve to allow continuous rotation when bent past 90 degrees. Levered tightening torque is applied by unfolding the handle in a extended length.

U.S. Pat. No. 4,748,875 to Lang discloses a reversible ratchet wrench employing spaced plates which hold the sockets and ratchet mechanism in assembly has an offset handle to provide clearance for the hand of the user. The pawl of the ratchet mechanism is in the head portion of the wrench adjacent the socket and the spring-loaded plunger is supported in the handle portion. The pawl and plunger engage at an oblique angle at a juncture zone between the handle portion and the socket head portion, which juncture zone affords clearance for operative movement of the ratchet and plunger during use. Lang's ratchet mechanism is used in a hand held wrench, and applies no useful work to the fastener in the when turned in the ratcheting direction.

### OBJECTS AND ADVANTAGES

Accordingly, several objects and advantages of my invention are:

(a) to provide a screwdriver that provides the operator with high speed fastening by providing continuous uninterrupted rotation of the tool.

(b) to provide a screwdriver that reduces the tedious turning of the operators wrists during the fastening process as found in using ratcheting or traditional type screwdrivers. This twisting can eventually lead to carpal tunnel syndrome.

(c) to provide a screwdriver that has an operating advantage over traditional screwdrivers and insert bits, providing increased turning torque to fasteners.

(d) to provide a driver that provides the user with high speed fastening and tightening torque all incorporated into a traditional looking and functional screwdriver type hand tool providing normal driving operation when desired.

(e) to provide an inexpensive and relatively simple design to accomplish said objectives, which is flexible enough to be incorporated into a wide variety of screwdriver types and bits.

(f) to provide the operator the highest fastener driving efficiency of any hand powered screwdriver.

(g) to provide a screwdriver that provides all the objectives; accomplished with one hand gripping the tool, never having to re-grip the handle.

(h) to provide an insert bit, adaptor, or shank that when installed into a hand driver provides the objectives stated above.

(i) to provide a hand powered rotary tool that also provides the objectives stated above.

(j) to provide a bit, adaptor, or shank that converts a traditional ratcheting screwdriver into a high speed rotary tool, retaining the ability to apply rotational torque by twisting the handle.

(k) to provide a insert bit, insert bit adaptor, tool shank, or screwdriver that has a design that transfers an applied couple to a point on the tool to the tool's tip using the definition of a free vector.

Further objects and advantages of my invention will become apparent from a consideration of the drawings and ensuing descriptions.

### DESCRIPTION OF DRAWINGS

FIG. 1 shows a side view of a rotary insert bit showing the axis angle and bends, shown with a Philips working end and a ¼ hex drive end for use with bit drivers.

FIG. 2 shows a traditional Philips insert bit having the same shank and couple axis.

FIG. 3 shows a top view of the rotary insert bit.

FIGS. 4-6 show embodiments of the rotary insert bit with different values of bend angles maintaining the same axis angle.

FIG. 7 shows an embodiment of the rotary insert bit with a ball hex working end for driving fasteners.

FIG. 8 shows an embodiment of the rotary insert bit having a Philips working end and a round shank.

FIG. 9 shows an embodiment of the rotary insert bit with a square drive working end for driving square drive sockets.

FIG. 10a shows an embodiment of the rotary insert bit having an extended #2 Philips working end working end for driving fasteners in tight locations.

FIG. 10b shows an embodiment of the rotary insert bit having an extended #1 Philips working end working end for driving fasteners in tight locations.

FIG. 11 shows the embodiment of the rotary insert bit shown in FIG. 10a installed into a short ratcheting bit driver.

FIG. 12 shows the embodiment of the rotary insert bit shown in FIG. 1 installed into a common ratcheting bit driver.

FIG. 13 shows the embodiment of bit 39 installed into a short ratcheting bit driver.

FIG. 14 shows a side view of the embodiment of FIG. 12 in rotation about the final drive axis.

FIG. 15 shows a isometric view of the embodiment of FIG. 12 in a clockwise rotation about the final drive axis to drive a fastener, showing the handle traveling in a counter-clockwise direction about the bit couple axis.

FIG. 16 shows a top view of the embodiment of FIG. 12 in a clockwise rotation about the final drive axis to drive a fastener, showing the handle traveling in a counter-clockwise direction about the bit couple axis.

FIG. 17 shows a top view of the rotary bit used in FIG. 16, showing applied rotations and forces.

FIG. 18 shows a top view of the embodiment of FIG. 12 in a counter-clockwise rotation about the final drive axis to drive a fastener loose, showing the handle traveling in a clockwise direction about the bit couple axis.

FIG. 19 shows a isometric view of the embodiment of FIG. 12 in a clockwise rotation about the final drive axis to drive a fastener, showing the handle also traveling in a clockwise direction about the bit couple axis.

FIG. 20 shows a top view of the embodiment of FIG. 19 in a clockwise rotation about the final drive axis to drive a fastener, showing the handle also traveling in a clockwise direction about the bit couple axis.

FIG. 21 shows a top view of the rotary bit used in FIG. 20, showing the applied couple and the resultant forces and rotations.

FIG. 22 shows a top view of the embodiment of FIG. 12 in a counter-clockwise rotation about the final drive axis to drive a fastener loose, showing the handle also traveling in a counter-clockwise direction about the bit couple axis.

FIGS. 23-29 show rotary adaptors for transforming traditional insert bits and ratcheting bit drivers into continuous rotary drivers, all having a bit socket and hex drive with a axis angle.

FIGS. 30 & 31 show a rotary adaptor for transforming a ratcheting bit driver into continuous rotary driver, having a square drive working end and hex drive with a axis angle to use with square drive sockets.

FIGS. 32-35 show rotary adaptors for transforming traditional screwdrivers into continuous rotary bit drivers, all having a bit socket working end and shank clearance hole with a axis angle.

FIGS. 40-43 show rotary adaptors for transforming non-ratcheting bit drivers into continuous rotary bit drivers, all having a bit socket working end and ratcheting hex drive with a axis angle.

FIGS. 44 & 45 show a rotary adaptor for transforming a Philips screwdrivers into a continuous rotary bit driver, having a bit socket working end and a ratcheting Philips socket with axis angle.

FIG. 46 shows a continuous rotary bit driver, having a bit socket working end and a ratcheting handle with axis angle.

FIG. 47 shows a continuous rotary bit driver, having a bit socket working end and a ratcheting handle with axis angle.

FIG. 48 shows a continuous rotary square drive shank, having both a square drive working end and drive end with axis angle.

FIG. 49 shows the shank of FIG. 48 installed into a square drive ratcheting screwdriver handle.

FIG. 50 shows a continuous rotary ratcheting driver having a square drive shank working end with axis angle.

FIG. 51 shows a continuous rotary driver having a square drive working end and handle with axis angle.

FIG. 52 shows a continuous rotary driver having a ball hex working end and handle with axis angle.

FIG. 53 shows a continuous rotary driver having a square drive working end and large smooth gripping handle with axis angle.

FIG. 54 shows a continuous rotary driver having a bit socket working end and large smooth gripping handle with stop ridge with axis angle.

FIG. 55 shows a continuous rotary driver having a square drive working end and rotating handle with axis angle, allowing user to produce a couple on shank for tightening torque.

FIGS. 56 & 57 show a continuous rotary driver having a square drive working end and rotating handle with axis angle, a handle portion rigidly attached to shank allowing user to produce a couple for developing tightening torque to the fastener.

FIG. 58 shows a continuous rotary screwdriver having a Philips working end and handle portion rigidly attached to shank forming an axis angle, the end of the handle having a rotating handle to rest in the user's palm.

FIG. 59 shows a electronics style continuous rotary driver having a Philips working end and handle rigidly attached to shank forming an axis angle, the end of the handle having a radius end to rest in the user's palm.

List Reference Numerals

| | | |
|---|---|---|
| 10 Rotary Insert Bit | 46 Rotary Insert Bit Adaptor | 89 Applied |
| 11. Insert Bit | 47 Rotary Insert Bit Adaptor | 90 Couple |
| 12 Working End | 48 Square Drive | 92 Moment of the couple |
| 14 Mid Section | 49 Clear Hole (blind) | 108 Raised Dia. Portion |
| 16 Drive End (Shank) | 50 Bit Drive handle | 110 Continuous Drive Tool |
| 17 Leverage Angle | 52 Ratcheting Mechanism | 120 Free Spin Handle |
| 18 Leverage Bend | 54 Rotary Driver | 125 Knurled Section |
| 19. Mid Distance | 56 Ratcheting Rotary Insert Bit Adaptor | 130 Rigid Handle |
| 20 Drive Bend | 58 Top Plate | 140 Continuous Drive Tool |
| 21. Leverage Distance | 60 Bottom Plate | 150 Continuous Drive Tool |
| 22 Fastener Axis | 62 Pawl | 155 Free Spin Knob |
| 24 Final Drive Axis | 64 Drive Gear | 160 Finger Surface |
| 26 Bit Couple Axis | 66 Pawl Spacer | 170 Gripable Surface |
| 27 Hex Drive | 68 Ball Plunger | |
| 28 Torque Distance | 70 Plate Spacer | |
| 30 Axis Angle | 72 Bit Socket (Holder) | |
| 32 Drive Angle | 74 Rivets | |
| 34 Drive Length | 76 Spring | |
| 36 Shaft Length | 78 Bit Socket Assembly | |
| 38 Axis Intersect | 80 Ratchet Assembly | |
| 39 Rotary Bit | 82 Drive Gear | |
| 40 Short Bit Driver | 84 Bit Adaptor | |
| 42 Bit Driver | 86 Drive Gear | |
| 44 Fastener | 88 Rotary Bit Driver | |

### SUMMARY

The principal object of the rotary driver is to provide uninterrupted continuous rotation when driving rotary fasteners in very low to moderately high torque situations, and allows normal tightening methods when fastening torque increases beyond this range, all with one hand. In addition, invention allows user to apply more turning torque towards the fastener then normal screwdrivers.

When using the common screwdriver, the operator must twist the tool as far as physically possible while applying a longitudinal force towards the fastener, then release their grip on the tool handle while holding the tool in the new position with their other hand, un-twist the wrist and re-grip the tool; repeatedly until the fastener is installed.

Similarly, in ratcheting screwdrivers, the operator's wrist must twist the tool back and forth while applying a force towards the fastener until the fastener is installed. The ratcheting type hand tools also do not work well when there is not enough torque to let the ratcheting mechanism function properly, requiring the operator to turn the fastener or tool shank with their fingers by methods including knurled shank sections. The driving efficiency in either type is low.

The rotary driver accomplishes its objectives by providing a turning mechanism that replaces the twisting of the wrist (associated with most screwdrivers) with rotation of the wrist. The different muscle groups used in rotating a screwdriver as compared with the rotary driver can be clearly illustrated by the following example: Compare sharpening a pencil with a hand held twist type verses the style having a crank arm spinning a cutting mechanism. The later is much faster to use, and doesn't require twisting of the wrist to perform the sharpening. With this in mind, it is clear to see how beneficial the rotary driver can be in a world full of rotary fasteners.

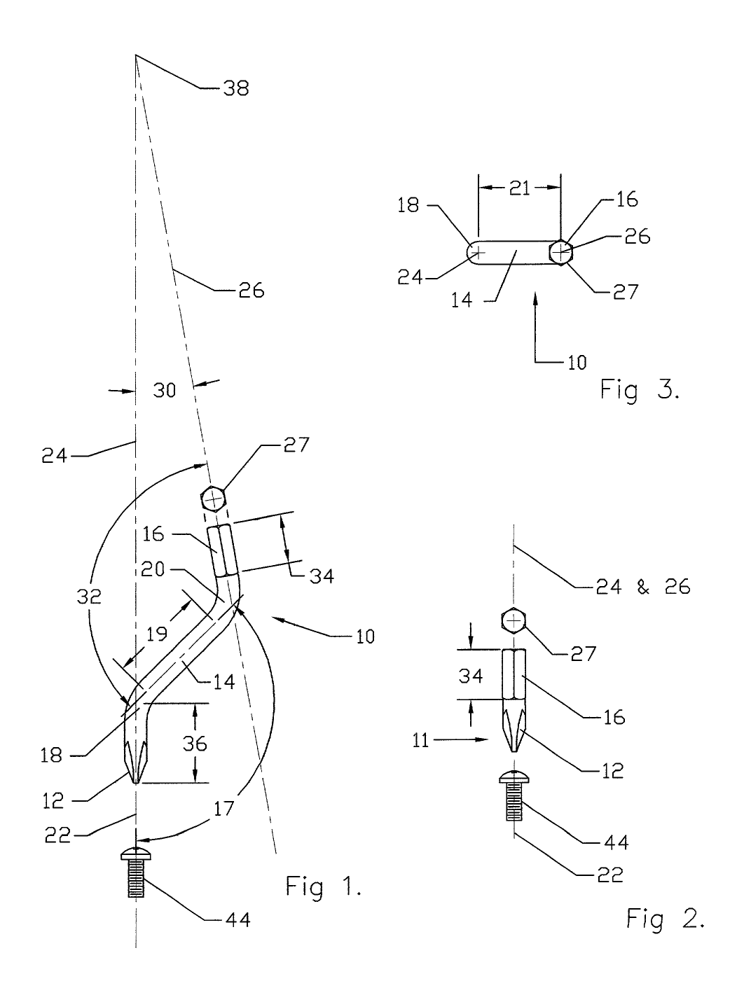

Description—FIGS. 1-12 (Rotary Insert Bits)

A typical embodiment of the rotary insert bit 10 is shown in FIGS. 1, 3-11. It has three major sections: working end 12, mid section 14, and drive end 16; each section having additional unique features. Bit 10 shown in FIG. 1 has similar features to a normal insert bit 11 shown in FIG. 2, except that increased length and bending processes transform it into a unique rotary bit 10. It is mainly intended to be used in conjunction with ratcheting type screwdrivers, however, it does work in non-ratcheting type bit drivers in traditional bit fashion, but provides added turning torque over conventional bits due to the offset shank acting as a lever arm.

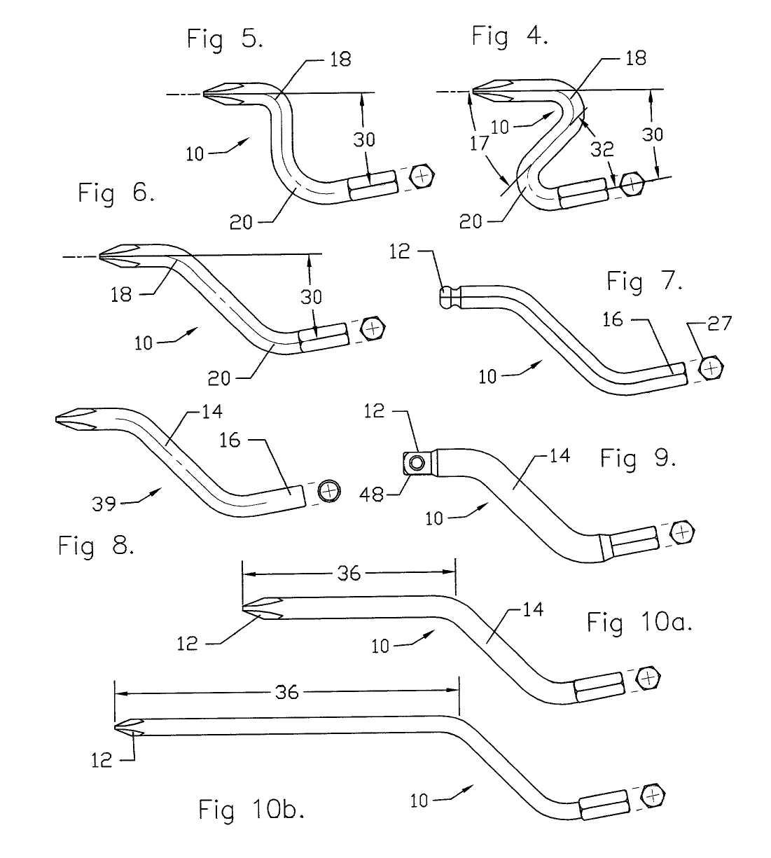

The working end 12 of bit 10 is formed or machined into many different driving style tips such as Flat tips, Phillips, Hex, Ball Hex, Pozidriv, Torx, ACR, Square drive, and countless others in many different sizes and lengths to drive fasteners. Some of these types are shown in FIGS. 1, 3-11. Referring again to FIG. 1, drive axis 24 is the centerline of end 12, and matches the fastener's axis 22 of rotation. Slight angles to this alignment are acceptable in most cases. Mid section 14 of bit 10 is formed away at leverage bend 18 at leverage angle 17 from rotational axis 22 & 24, and extends at a mid distance 19 that determines the level of leveraged torque the operator can apply for rotation by applying the simple equation for torque as force times distance. FIG. 3 shows a top view of bit 10 showing an effective leverage distance 21 for applying rotational torque. Referring back to FIG. 1, mid section 14 is then formed at drive bend 20 back towards drive axis 24 at drive angle 32 such that drive end 16 having couple axis 26, is intersecting or crossing the fastener's rotation axis 22 at axis intersect 38. Axis 26 and axis 24 form axis angle 30, and its value found to be around 0 to 15 degrees for a comfortable rotation range for the wrist, with about 6 degrees being the preferred value. FIGS. 4-6 show that many different values for bends 18 & 20 for can be made on the invention, and still keep the same value for angle 30. These embodiments all show angle 30 at 10 degrees, with varying values for bends 18 and 20.

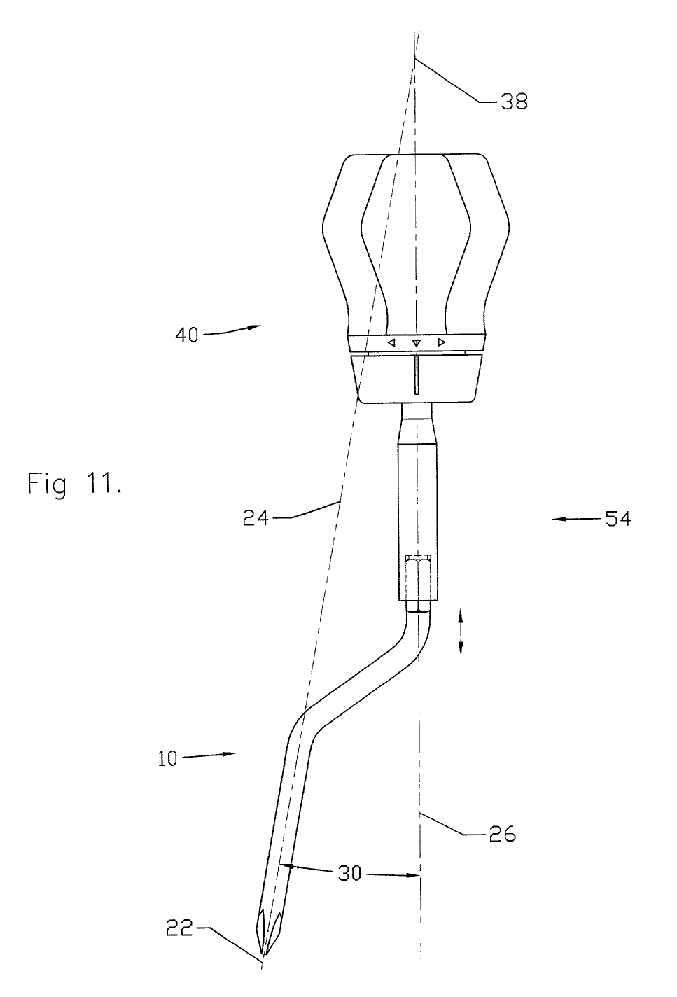

Insert bit hex shanks are generally manufactured in either ¼″ or 5/16″ hex. FIG. 7 shows an embodiment of bit 10 having a ball hex end 12, and entirely made from ¼″ hex stock to form the common hex drive 27 at end 16, as seen used with the common insert bit 11 in FIG. 2. Drive 27 has a drive length 34 to slide into closely matched hex pockets common in bit drivers, called bit holders in the industry. They typically have a few thousands of an inch clearance with the shank, around 0.255″ for ¼″ hex stock. Shown installed in FIG. 11, such pocket design allows driver 40 to transmit torque to the insert bits, and provides easy removal. The pocket depth varies from manufacturer to manufacturer, but is generally in the 5/16″ to 7/16″ range. A magnet, threaded cap, or spring retaining ring in the bit holder generally retains drive end 16 in place. Since bit 10 is designed to be interchangeable with insert bits, Drive 27 of the bit 10 is designed to match or utilize any retaining methods or pocket shapes to retain it into bit drivers or similar rotary hand tools with interchangeable shanks and tool tips.

FIG. 9 shows an embodiment of bit 10 having section 14 in round stock and a square drive 48 end 12 configuration for use with common sockets and square drive tools. In some cases a smaller diameter for the body and working end 12 is desired as shown in FIGS. 10a & 10b. FIG. 10a depicts an embodiment of bit 10 as a common #2 Phillips end 12 having a extended shaft length 36. FIG. 10b shows another embodiment of bit 10 having a #1 Phillips end 12 having a even greater extended length 36. These extensions are useful when the rotation of section 14 may interfere with the work assembly it is employed on. This is illustrated in the compact embodiment depicted in FIG. 4, where angles 17 and 32 are acute, useful where work clearance around the fastener is not a concern.

The embodiment in FIG. 8 shows rotary bit 39 having section 14 and drive end 16 made from ¼″ round stock. Since traditional bit holders are designed for accepting ¼″ hex stock as described above, this embodiment's ¼″ diameter end 16 slips into such designed pockets, allowing concentric rotation within.

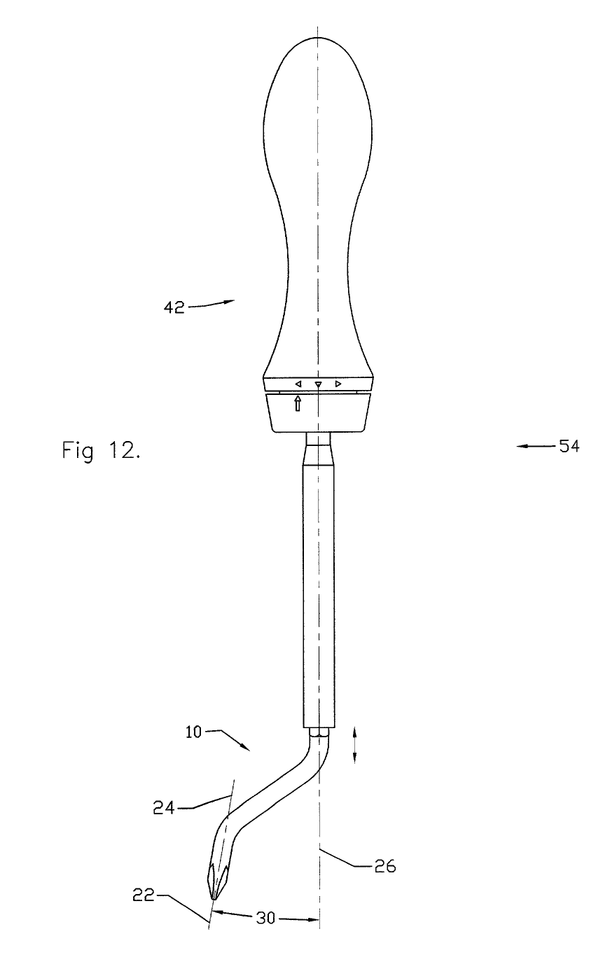

Rotary driver 54 is made by installing bit 10 into a common bit driver 42 or similar rotary hand tool as shown in FIG. 11. Intersect 38 located behind the driver 40's grip, at a point coinciding with a operators wrist pivot. FIG. 12 shows Rotary driver 54 with a traditional length driver handle.

Bit 10's choice of material and heat treatments would follow traditional insert bit choices such as steel, tool steel, and alloys with a variety of heat treatments to ensure long tool life and reduced wear.

Description Ramifications—FIGS. 1-12 (Rotary Insert Bits)

While the embodiments described and illustrated are shown incorporated into a common bit ratcheting screwdriver, it will be appreciated that many other screwdriver type hand tools could be used. It is also appreciated that the ¼″ hex drive end can also be substituted with many shapes or sizes including square drive, to achieve the same function, additionally making it possible to design a specific line of rotary bit driving tools having matching holding pockets to accept matching rotary bits. Power bits are generally longer than insert bits, and are designed for use in powered rotary tools such as drills. These bits can be transformed into the invention by a bending process, allowing economical and relatively fast conversion to high speed rotary bits.

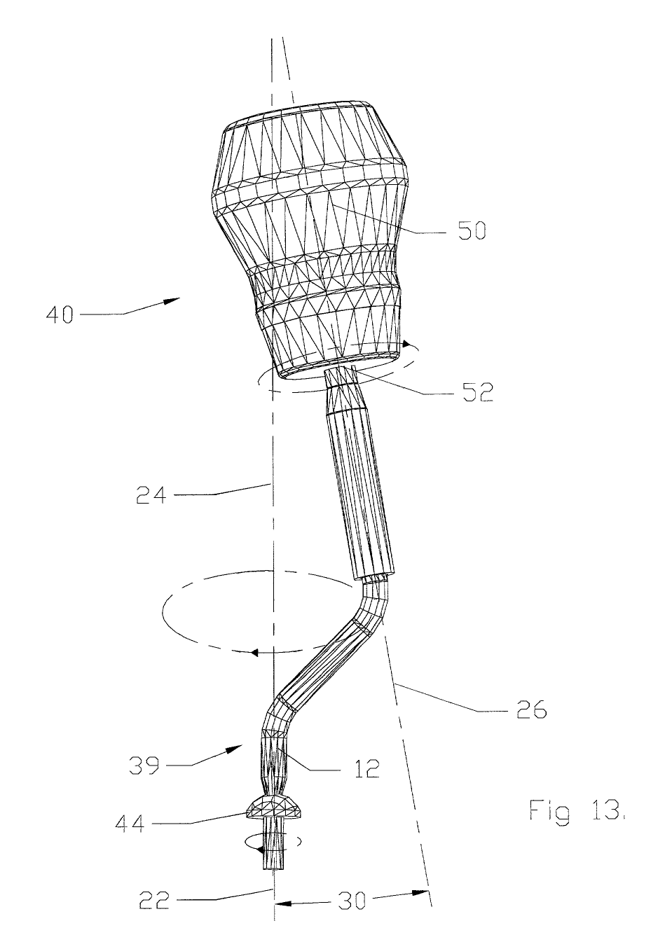

Operation—FIGS. 13-22 (Rotary Insert Bits)

A simplistic operation of the invention is shown in FIG. 13, employed to install fastener 44. The figure depicts bit 39 being retained magnetically in a Non-ratcheting Driver 40. The entire operation is intended to be done with the use of only one hand. While applying force directed towards fastener 44 along axis 22 with a hand on bit driver handle 50, the operator concurrently rotates driver 40 about axis 22 in a clockwise manner, pivoting at the wrist to sweep or trace a cone shape with axis 26 about axis 22. In such fashion, this invention allows the operator to transmit an applied force along axis 22 to maintain a good couple between end 12 and fastener 44, and apply continuous rotational torque (not twisting) from the wrist to drive the fastener. Since bit 39 is retained and rotates within driver 40's bit pocket, it also rotates in a clockwise direction about axis 24 to drive fastener 44 with the operators force acting on the leverage distance 21 shown in FIG. 3. This embodiment, however, requires the operator to apply tightening torque on fastener 44 with the rotation of the wrist, which is not as effective as the traditional method of twisting the driver to apply torque.

At this point a note about Ratcheting screwdrivers should be made. They are designed to allow the operator to apply torque in one direction and free wheel or ratchet in the opposite direction by twisting the wrist. The ratcheting mechanism is not designed to drive bits and fasteners, but to allow easy re-positioning of the operators wrist to apply additional torque without un-driving the fastener (this is a problem in very low torque fastening situations because the fasteners can unscrew while ratcheting the tool backwards). This rather low efficiency process is repeated over and over until the fastener is installed. It should be noted that almost half the driving time is spent rotating the tool in the wrong direction. It is impossible for these drivers to install fasteners in ratcheting mode (backwards).

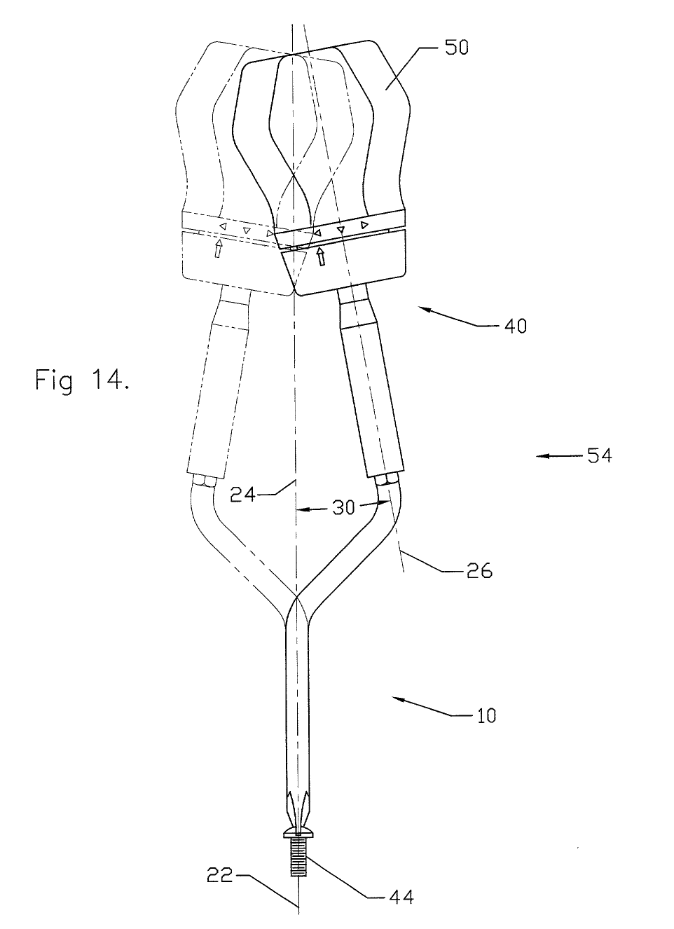

Referring to FIGS. 14-22, Driver 54 with the installation of Bit 10 reverses this use by allowing ratcheting mechanism 52 to operate backwards while still driving fastener 44 forward! Yes, as shown in FIGS. 14 & 15, bit 10 rotates in a clockwise rotation to install fastener 44, the operator applies a clockwise rotation to driver 40 by pivoting at the wrist as described above for FIG. 13. It should be noted that mechanism 52 of driver 40 is switched to drive fasteners forward. Mechanism 52 then travels in reverse (or free wheels) because the operator by keeping a firm grip on handle 50, is actually turning it in a counter-clockwise rotation during the clockwise rotations with respect to driver 40 tool's shank (axis 26). This function is similar to the operation of the embodiment of FIG. 13, with mechanism 52 accounting for the rotation within the bit pocket of bit 39. The faster the operator rotates driver 40, the faster the fastener 44 is turned. This is extremely useful in very low torque situations where normal ratcheting screwdrivers fail as described above.

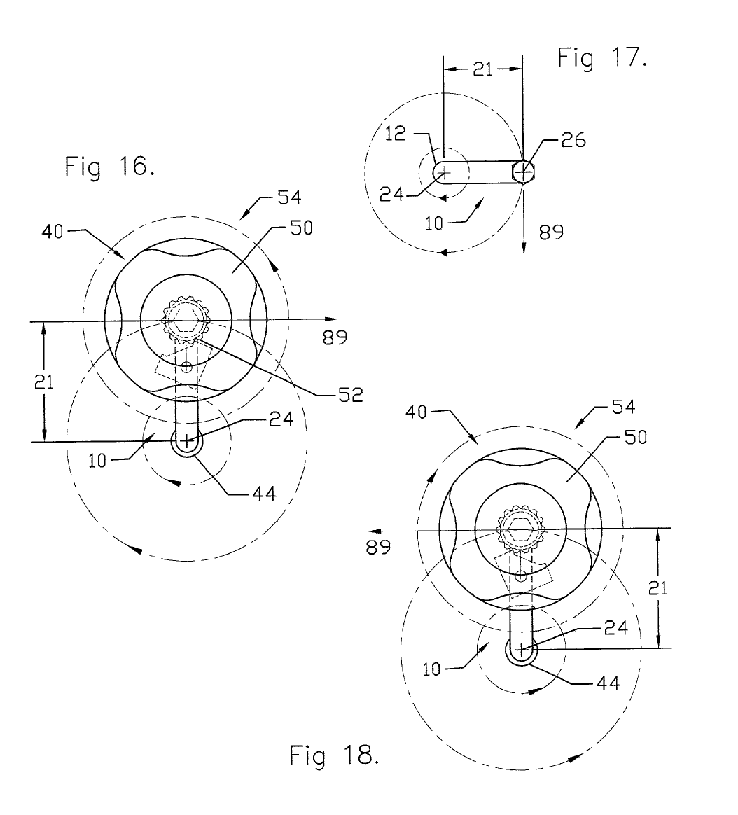

FIG. 16 shows a top view of driver 54 employed to install fastener 44, with a very simplistic ratcheting mechanism 52 shown in driver 40 to further describe the operation. As a operator applies applied force 89 to rotate driver 54 in a clockwise direction about axis 24 as described above, bit 10 and thus fastener 44 also rotate in a clockwise direction. This is possible because the pivotly mounted pawl of mechanism 52 allows handle 50 to rotate in a counter-clockwise direction with respect to driver 40's geared shank as shown. This allows handle 50 to keep its orientation within the operators hand during its rotation about axis 24 as described. FIG. 17 shows a top view of bit 10 in continuous rotation about axis 24, where the operator's tangential force 89 at distance 21 provides the turning torque in this operation. In FIG. 18, driver 54 is employed to remove fastener 44. For this operation, mechanism 52 is switched to allow handle 50 to rotate in a clockwise direction with respect to driver 40's geared shank as shown. In this employment, driver 54 is operated in a counter-clockwise direction about axis 24, and thus bit 10 and fastener 44 also rotate in a counter-clockwise direction to remove fastener 44.

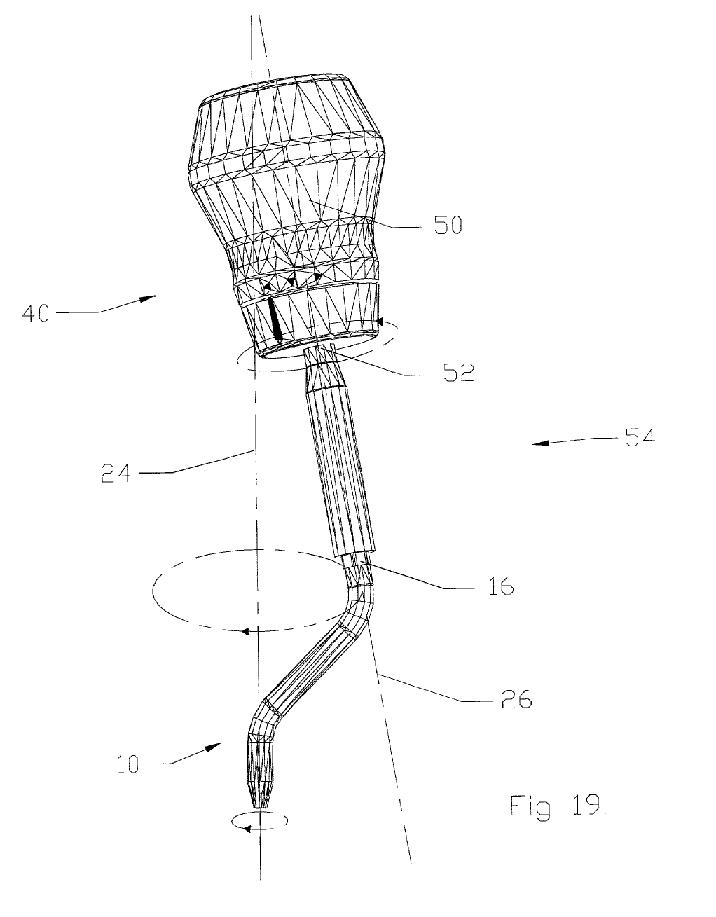

In high torque situations when the operator can not apply enough rotational torque to maintain smooth continuous rotation with the wrist as described, they simply introduce twisting of the wrist on handle 50, and driver 54's ratcheting mechanism 52 functions normally and turns bit 10 in a proper direction for installing a fastener as shown in FIG. 19. This is possible due to the clockwise mechanical couple 90 the operator is producing on rotary bit 10 with driver 40 at end 16 that tends to rotate it about its axis 24 as shown in FIG. 21. In the study of vector mechanics in engineering statics and dynamics, it is learned that a couple applied to a body tends rotate it about its axis. Couples are represented by a vector called the moment of the couple, and a moment of a couple is a free vector, and can be applied at any point on the body. Therefore, the couple 90 applied at end 16 is transferred to working end 12, represented by a moment 92 vector. The result is tightening torque applied to fastener 44 with only twisting of the wrist on the invention, as seen in the similar operation of the common screwdriver. It is noted that since the transferred couple is at a slight angle to axis 24 due to angle 30, the vector component along axis 24 provides the driving torque.

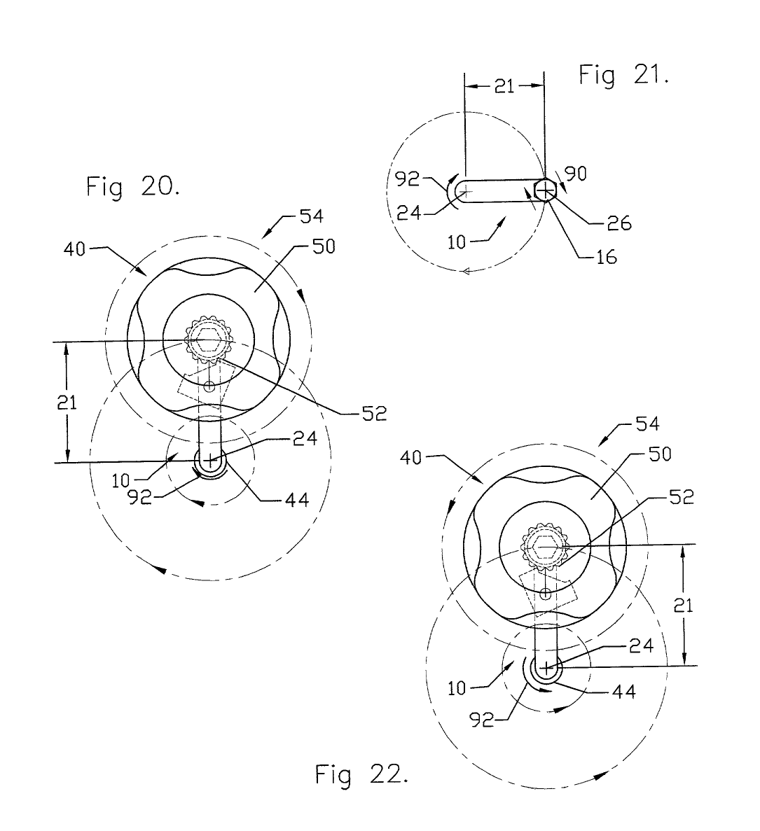

FIG. 20 again shows the description further in the installation of fastener 44. Mechanism 52 is in the same position as in FIG. 16 for continuous clockwise rotation, but now the operator applies a clockwise twist on handle 50. Now the pivotly mounted pawl of mechanism 52 engages the gear and transmits the twisting torque on handle 50 to driver 40's geared shank as shown. This produces couple 90 at end 16 described in FIG. 21. FIG. 22 shows the reverse action as driver 54 is employed to loosen and remove fastener 44. Mechanism 52 is in the same position as in FIG. 18 for continuous counter-clockwise rotation, but allowing the operator to first apply a counter-clockwise twist on handle 50 to provide a loosening torque on fastener as shown.

The transition from rotational to twisting torque on driver 54 is seamless, and provides both continuous and normal operation of ratcheting driver 40 with installation of Applicant's unique rotary bit 10 invention. Also, when combined, the twisting and rotational torques on the invention produce higher torque levels on fastener 44 then normal bit 11 due to the lever arm effect of distance 21, and therefore can apply more turning power.

During the rotation of the rotary bit 10 in low to moderate torque levels, the operators wrist on the handle does not twist, providing a simple and non-fatiguing method of turning the rotary driver. The tool can be rotated rapidly to quickly drive fasteners. Applicant's bit 10 invention plays a unique and integral role in the function of rotary driver 54 by allowing users to provide a steady driving force towards the fastener and apply continuous rotational torque requiring only one hand to operate.

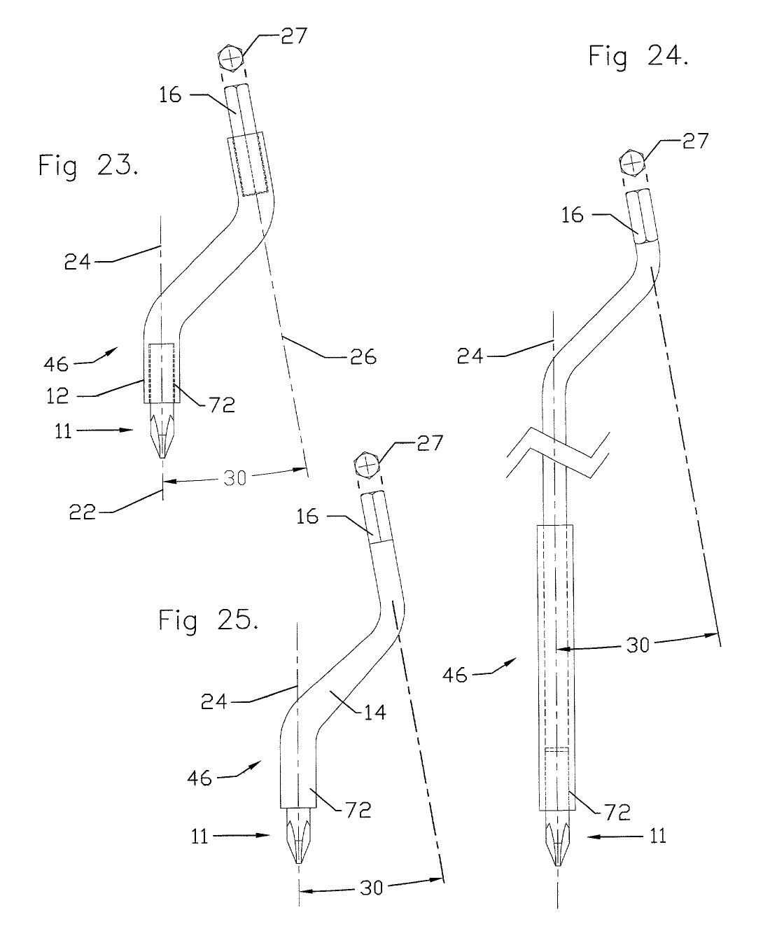

Description—FIGS. 23-31 (Rotary Insert Bit Adaptor 46)

FIG. 23 depicts rotary insert bit adaptor 46 with a bit socket at working end 12 and drive end 16 with hex 27. This embodiment of the invention is a natural evolution and allows use of standard insert bits like bit 11 shown in FIG. 2 to be used in the same function as rotary insert bit 10.

Additional embodiments of adaptor 46 are shown in FIGS. 24-31. FIGS. 23-31 are mainly used in conjunction with ratcheting type screwdrivers or bit drivers. The design uses the same unique features described for the rotary bit 10 above, but in a format that allows standard insert bits to be used in a continuous, uninterrupted rotation. This allows owners of such ratcheting tools the option to adapt them to continuous rotation and still utilize their own collection of insert bits.

FIG. 23 shows that adaptor 46 retains all the unique features described for rotary bit 10 above. In FIGS. 23, the body of adaptor 46 is made from round stock or tubing, having a bit pocket machined into end 12, and hex 27 permanently fixed to end 16. FIG. 24 shows an embodiment of adaptor 46 with a extended length 36 similar to the embodiment of FIG. 7. End 12 is fitted with a permanently fixed bit pocket tube designed to accept and retain insert bits as described. FIG. 25 shows another embodiment of adaptor 46 having the body formed from round stock, having a bit pocket machined into end 12, and hex 27 formed into end 16.

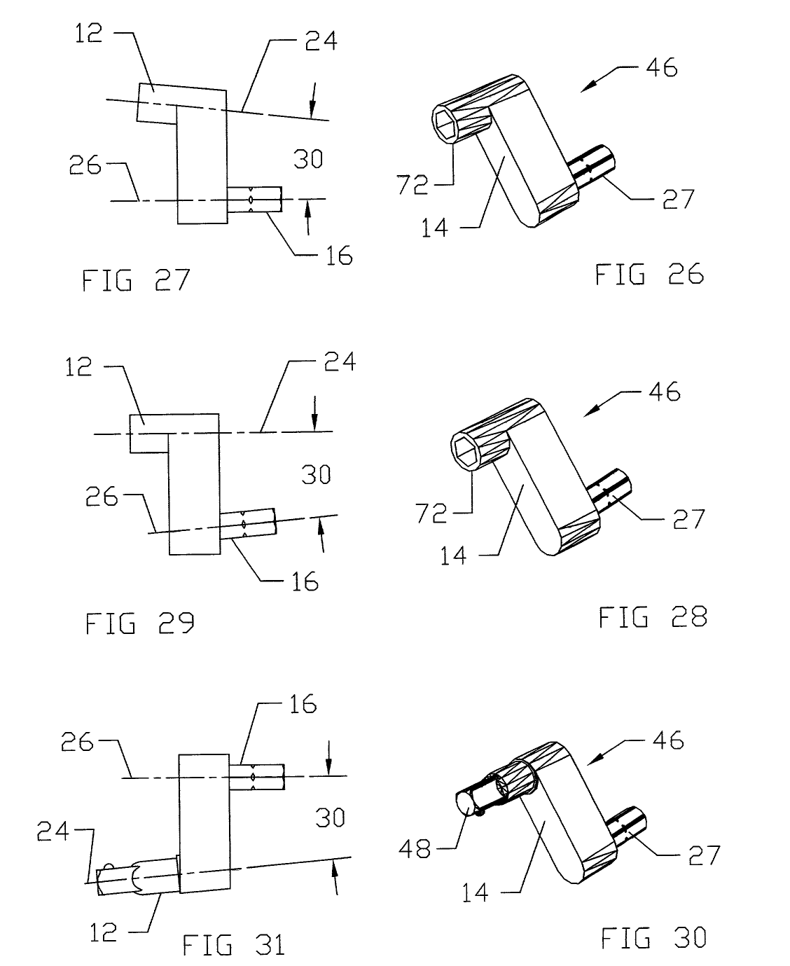

FIGS. 26-31 show additional embodiments of adaptor 46 having working end 12 and drive end 16 incorporated into mid section 14. All embodiments contain the unique features described for bit 10, including angle 30. FIGS. 26 & 27 show end 12 formed into a bit socket, with end 16 having hex 27 pressed into section 14 at about 90 degrees. This allows section 14 of adaptor 46 to be somewhat perpendicular to driver 40. FIGS. 28-29 show end 12 formed into a bit socket about 90 degrees with respect to section 14. Hex 27 of end 16 is pressed into section 14 at an angle to accommodate preferred values of axis angle 30. This allows section 14 of adaptor 46 to be somewhat perpendicular to insert bit 11. FIGS. 30-31 show an embodiment of adaptor 46 having drive end 16 in hex 27 and working end 12 formed into a square drive.

While the embodiments described and illustrated are shown to be incorporated into a common bit ratcheting screwdrivers, it will be appreciated that many other screwdriver type hand tools could be used. It is also appreciated that the ¼″ hex can also be substituted with many shapes or sizes including square drive to achieve the same function, making possible a specific line of rotary bit driving tools having matching holding pockets to accept adaptor 46.

Operation—FIGS. 23-31 (Rotary Insert Bit Adaptor 46)

The operation of adaptor 46 is the same as described for rotary bit 10 above, with the addition of insertion of a insert bit or fastening drive tool into working end 12.

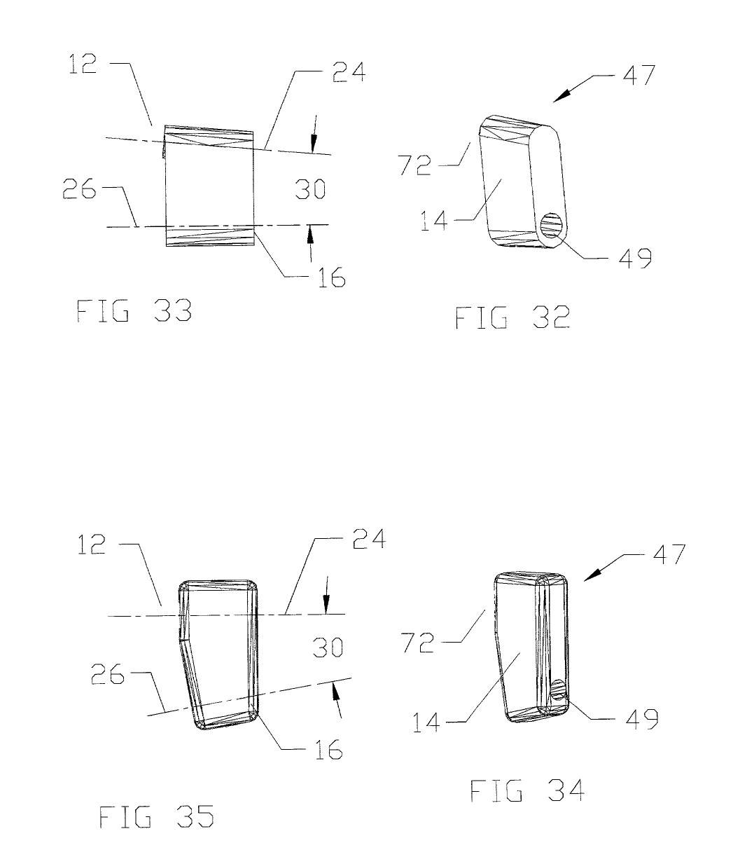

Description & Operation—FIGS. 32-35 (Rotary Insert Bit Adaptor 47)

FIGS. 32-35 depict rotary insert bit adaptor 47 with a bit socket at working end 12 and drive end 16 with blind clearance hole 49. This embodiment of the invention allows use of standard insert bits like bit 11 shown in FIG. 2 to be used in similar function as rotary bit 39 in FIG. 13. Further, it allows the use of common Philips screwdrivers to produce the continuous rotation described for the invention.

The design uses the same unique features described for the adaptor 46 above, but uses a blind clearance hole 49 for end 16 to accept a Philips standard tipped screwdriver. When inserted, adaptor 47 is rotated about axis 24 just like bit 39 described above. While applying force directed towards fastener 44 along axis 22 with a hand on the screwdriver handle, the operator concurrently rotates it about axis 24 in a clockwise manner, pivoting at the wrist to sweep or trace a cone shape with axis 26 about axis 24. In such fashion, this invention allows the operator to transmit an applied force along axis 22 to maintain a good couple between end 12 and the fastener 44, and apply continuous rotational torque (not twisting) from the wrist to drive the fastener. Since the screwdriver tip is in a blind hole and rotates within hole 49, it also rotates in a clockwise direction about axis 24 to driver fastener 44.

This embodiment does not allow for twisting type tightening or loosening torque, however the design of mid section 14 allows for easy application of leveraged torque by grasping it with the hand and rotating it about axis 24.

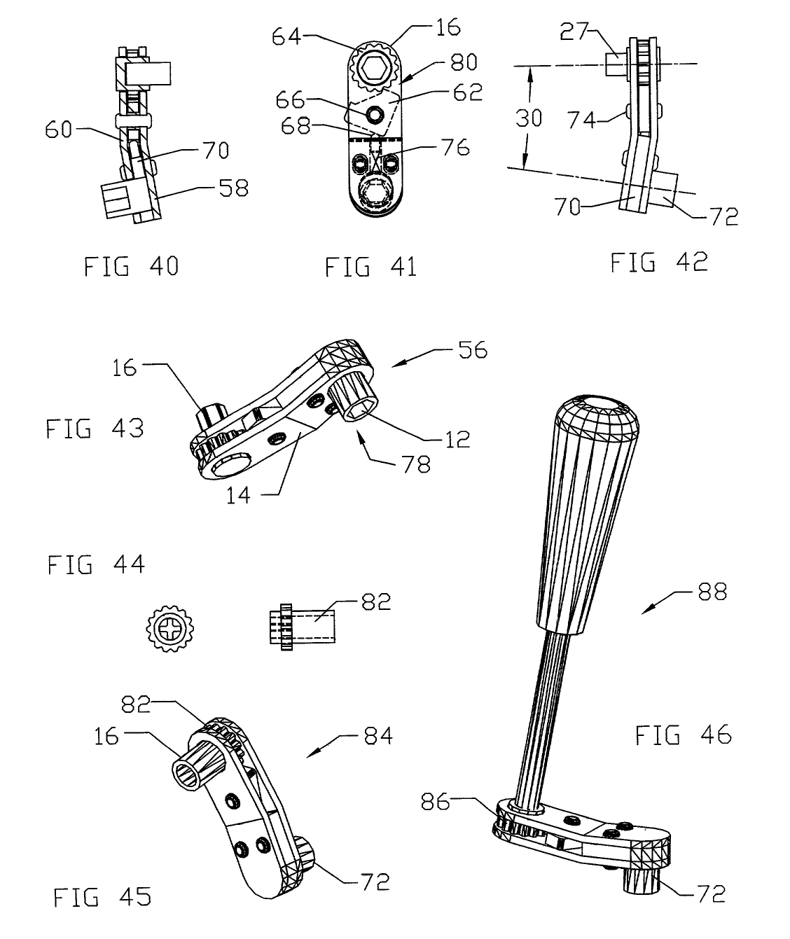

Description—FIGS. 40-46 (Ratcheting Rotary Insert Bit Adaptors)

FIGS. 40-43 depict a ratcheting insert bit adaptor 56 that does not require a ratcheting bit driver to facilitate its use because a ratcheting mechanism is incorporated into the drive end 16. In this embodiment, mid section 14 is made from two bent plates, top plate 58 and bottom plate 60. FIG. 40 shows a side view of adaptor 56 with plates 58 & 60 sandwiching plate spacer 70. Bit socket assembly 78 is composed of spacer 70 permanently fixed to bit socket 72, and forms working end 12. Assembly 78 is secured between plates 58 & 60 with rivets 74. Referring to FIG. 41, drive end 16 is composed of ratchet assembly 80, made from drive gear 64 engaging pawl 62. Pawl 64 has a clearance hole and is pivotly mounted on pawl spacer 66, assembly 80 secured between plates 58 & 60 with rivet 74. Ball plunger 68 and spring 76 are mounted in spacer 70, and press pawl 62 against gear 64. As with bit 10, the axis of adaptor 56 end 12 and end 16 form axis angle 30 as shown in FIG. 42. End 16 in this embodiment is finished in hex 27 to be used with non-rotating bit drivers.

FIG. 45 also shows a ratcheting insert bit adaptor 84 that uses a standard Philips or flat blade screwdriver into the drive end 16. In this embodiment, a the standard screwdriver slips down into drive gear 82, and is locked into a cross shaped cutout in its base. FIG. 44 shows gear 82 in further detail, showing a extended tube with clearance hole for the screwdriver. The base cutout is designed to match and engage the blade(s) at the tip, allowing the screwdriver to rotate gear 82.

The embodiment of rotary bit driver 88 shown in FIG. 46 takes adaptor 84 one step further by incorporating a handle within drive gear 86. In this embodiment, driver 88 is a complete tool for driving insert bits by providing both continuous and normal ratcheting operation.

Operation FIGS. 40-46 (Ratcheting Rotary Insert Bit Adaptors)

The operation of adaptor 56, 84, and driver 88 is the same as described for rotary driver 54 above, with the addition of insertion of a insert bit or fastening drive tool into working end 12, and having the ratcheting mechanism 52 incorporated in to the embodiments.

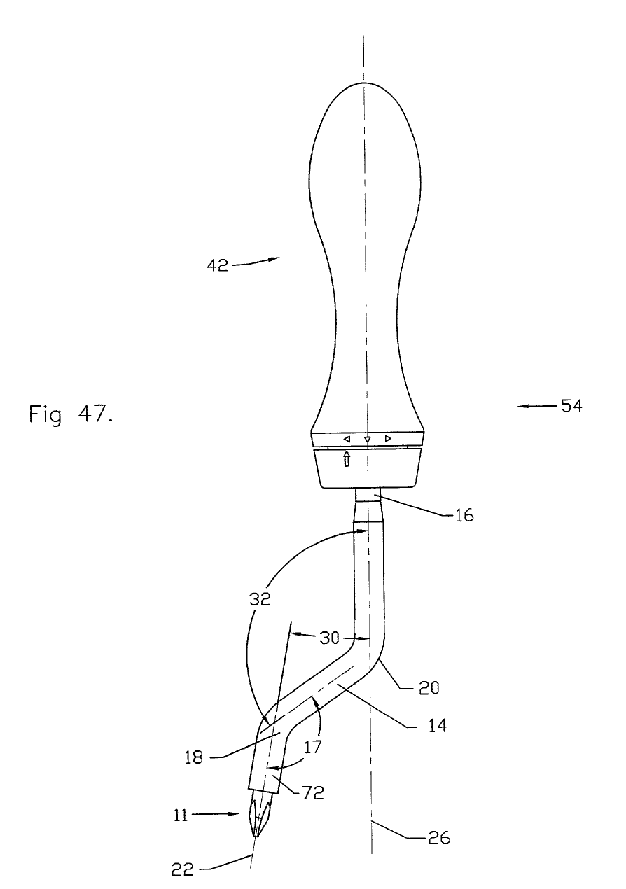

Description/Operation—FIGS. 47-50 (Rotary Tool Shanks for Ratcheting Screwdrivers)

Typical embodiments of the rotary tool shanks for ratcheting screwdrivers are shown in FIGS. 47-50. These shanks are incorporated into ratcheting type screwdrivers or bit drivers. The design uses the same dimensions described for the rotary bit 10 above, but in a format that allows standard insert bits or square drive tools to be used in a continuous, uninterrupted rotation. The axis or centerline of the bit retaining end 12 of the tool shanks match the fastener's axis of rotation. As stated before, slight angles to this alignment are acceptable in most cases. In the embodiment shown in FIG. 47, the mid section of the shank is bent away from this rotational axis at a distance that determines the level of torque the operator can apply for rotation. The mid section is then bent back towards the rotation axis such that the centerline of the adaptor intersects or crosses the fastener's rotation axis.

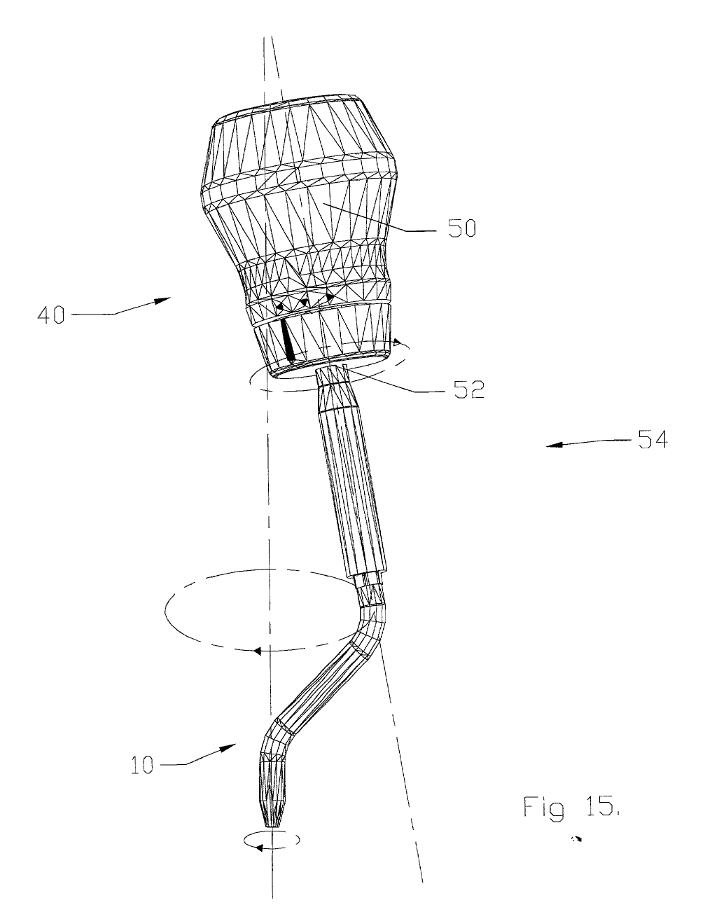

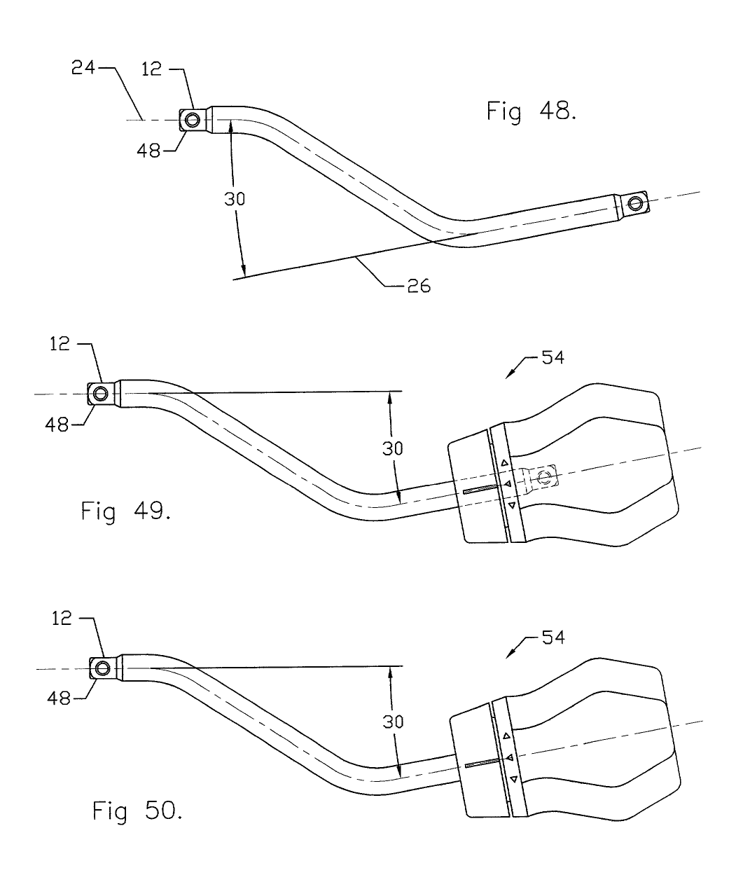

FIG. 48 is similar to FIG. 9 described above, except end 16 is formed into square drive 48. This embodiment allows insertion into square drive socketed ratcheting drive handles as shown in FIG. 49. This embodiment functions similar to the embodiment described in FIGS. 15-22, except it is employed to drive common square drive tools and accessories such as sockets. FIG. 50 shows an embodiment of a ratcheting driver with a shank having square drive 48 end 12, formed to the unique dimensions as described for bit 10 above to provide the same continuous and intermittent rotation as described for driver 54.

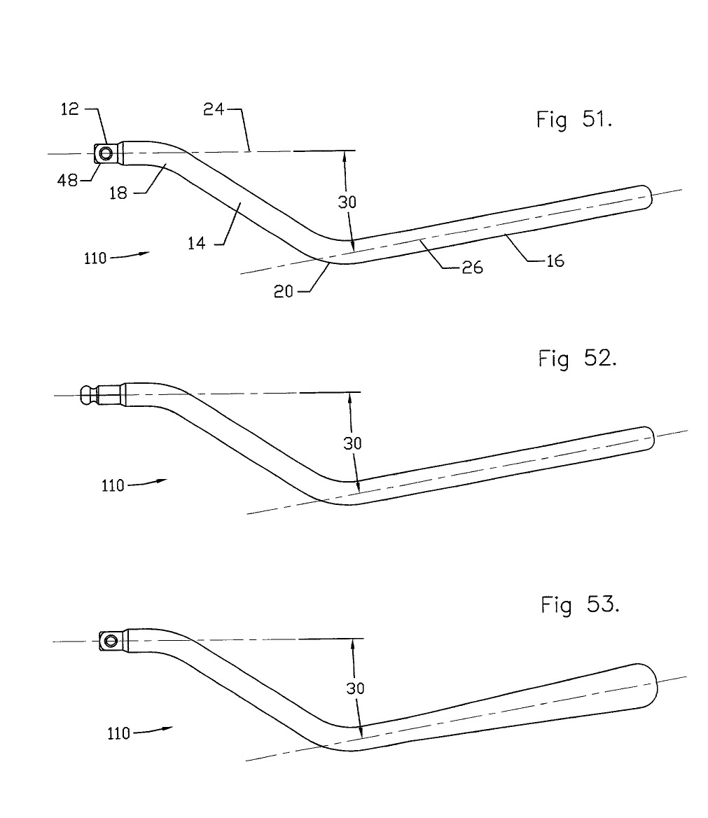

Description—FIGS. 51-54

The continuous drive tool 110 shown in FIGS. 51-54 is similar to the embodiments described for bit 10 above, except drive end 16 has an extended drive length 34 to form a gripable handle for the operator. End 16 is generally a smooth, round shape in sizes ranging from about ¼″ to 1″ diameter, designed to fit comfortably in the user's grip. End 16 is generally rounded at its end to comfort the user. FIG. 51 shows an embodiment with end 12 formed into drive 48.

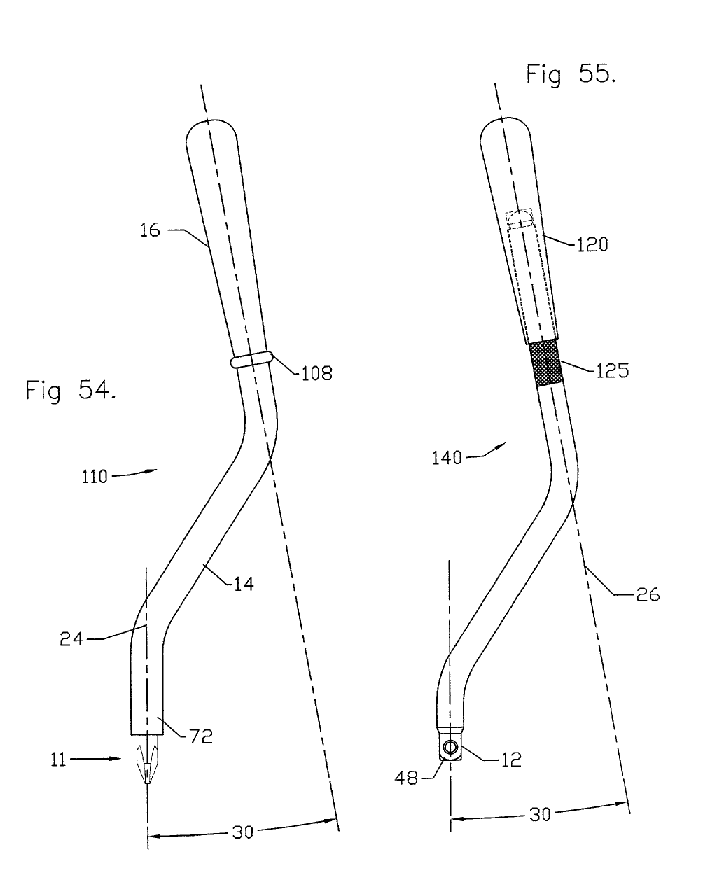

Similarly, FIG. 52 shows a embodiment having a ball hex for end 12. FIG. 53 shows the embodiment of FIG. 51 having the gripable portion of end 16 tapered to further comfort user. FIG. 54 shows an embodiment of the invention where the drive length 34 of end 16 contains a raised larger diameter portion 108, and finished with a round increasing taper to its end. End 12 is formed into a bit socket for driving insert bits like bit 11.

Operation—FIGS. 51-54

Tool 110 functions similar to the embodiment described in FIGS. 15-22, except the operator's hand gripping the invention is employed to function as ratcheting mechanism 52. Since end 16 is generally round and smooth as described above, and is made of hard material such as plastic, steel or aluminum, it is capable of spinning within the operators hand when a loose grip on end 16 of the invention is used. This allows for the backwards or ratcheting rotation of handle 50 described above for the operation of FIGS. 14-22, but now the operators loose grip is traveling in a counter-clockwise rotation during the clockwise rotations with respect to tool 110's end 16 with axis 26. This operation allows rapid rotation of tool 110 to continuously drive rotary fasteners in the manner described above for driver 54.

In high torque situations when the operator can not apply enough rotational torque to maintain smooth continuous rotation as described, they simply change to a tight grip on end 16 of tool 110, and introduce twisting of the wrist on end 16, and the tool functions normally by allowing the operator to apply rotational torque to end 12, similar in the function shown in FIG. 19. Again, as described above this is possible due to the mechanical couple the operator is producing at end 16 on drive tool 110 that tends to rotate it about its axis 24, as similarly described in FIG. 21.

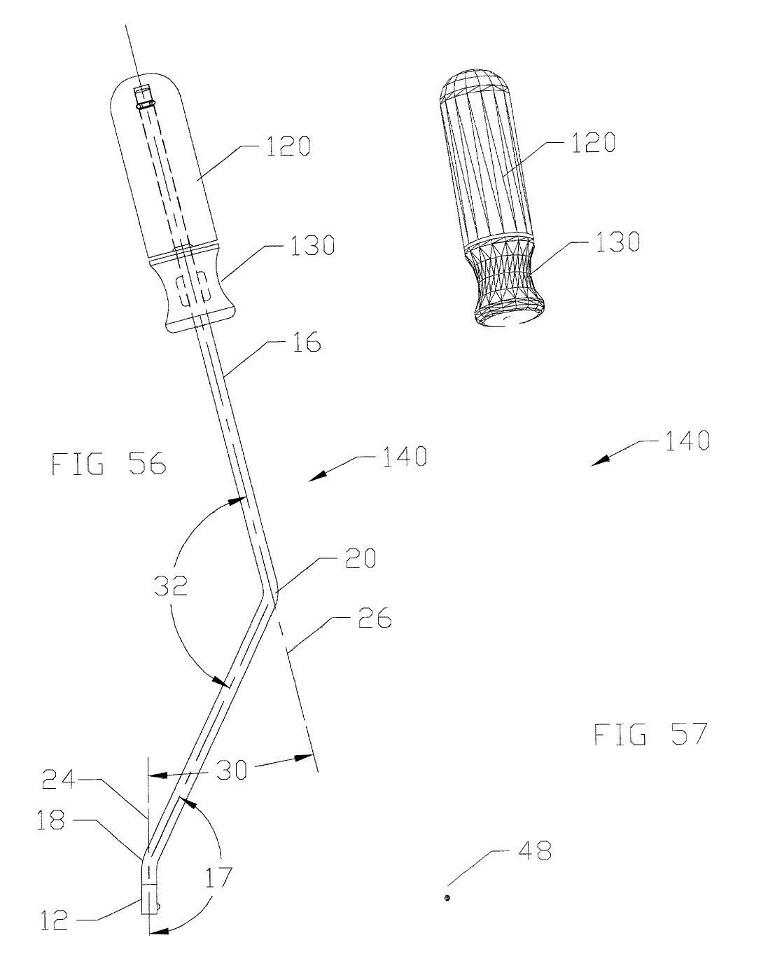

Description—FIGS. 55-57

FIGS. 55-57 are similar to the embodiments described for tool 110 in FIGS. 47-50 above, except the mechanism 52 function of driver 42 is simplified and incorporated into end 16. The embodiment shown in FIG. 55 shows continuous drive tool 140 with an extended drive length 34 with gripable free spin handle 120 rotatably attached at its end. Handle 120 rotates about axis 26, and is generally round in shape, in sizes ranging from about ¼″ to 2″ diameter, designed to fit comfortably in the user's grip. A portion of end 16 in front of handle 120 has knurled section 125. End 12 is formed in drive 48. The embodiment shown in FIGS. 56-57 show drive tool 140 with handle 120, and a gripable rigid handle 130 fixed to end 16.

Operation—FIGS. 55-57

The embodiments shown in FIGS. 55-57 also provide both continuous and intermittent fastener driving with one hand and function similar to the embodiment described in FIGS. 15-22, except the operators grip on handle 120 and handle 130 or section 125 in part function as ratcheting mechanism 52. Since handle 120 of tool 140 rotates about axis 26 as described above, it allows for the backwards or ratcheting rotation of handle 50 as described above for the operation of FIGS. 14-22, traveling in a counter-clockwise rotation during the clockwise rotations with respect to end 16 with axis 26. This operation allows rapid rotation of tool 140 to continuously drive rotary fasteners in the manner described above.

In high torque situations when the operator can not apply enough rotational torque to maintain smooth continuous rotation as described, they simply position a tight grip on section 125 or handle 130 of tool 140, and introduce twisting of the wrist. The tool functions by allowing the operator to apply rotational torque to end 12, similar in the function shown in FIG. 19. As described above this is possible due to the mechanical couple the operator is producing at end 16 on drive tool 140 that tends to rotate it about its axis 24.

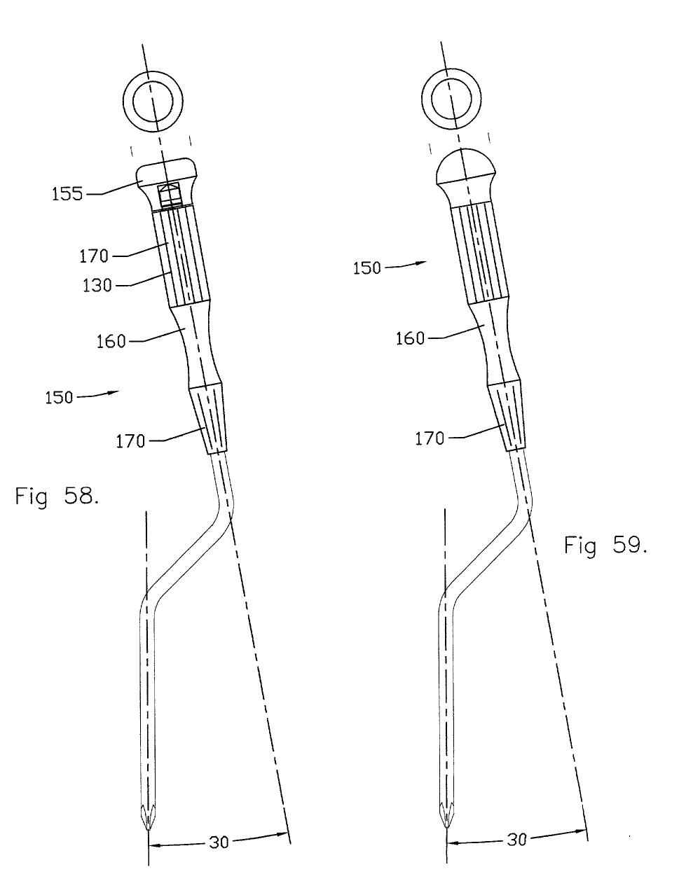

Description—FIGS. 58-59

Continuous drive tool 150 in FIG. 58 is similar to the embodiment described for FIGS. 56 & 57 above, except the invention is incorporated into the smaller electronic type screwdrivers that fit in the operators palm and are generally rotated with the fingers. The embodiment shown in FIG. 58 shows continuous drive tool 150 with an extended drive length 34 with a gripable rigid handle 130 fixed along a portion of its length. Handle 130 is generally round in shape, in sizes ranging from about 3/16″ to 1″ diameter, designed to fit comfortably in the user's palm. A at its end, and rotates about axis 26. To add greater comfort to the user, a free spinning knob 155 is rotatably attached at the top of the handle to protect the user from continuous 360 degree revolutions of the tool. Current miniature electronic handles of this type utilize the fingers to turn them intermittently, and are not designed for continuous rotation. End 12 is shown formed in a Philips drive. The embodiment shown in FIGS. 59 shows a radius at the distal end of handle 130 to allow comfort during continuous rotation against the users palm. Handle 130 has a smooth finger surface 160 to allow fingers to glide against during continuous rotation. A gripable surface 170 makes up the remainder of handle 130.

Operation—FIGS. 58-59

The embodiments of drive tool 150 shown in FIGS. 58-59 also provide both continuous and intermittent fastener driving with one hand and function similar to the embodiment described in FIGS. 15-22, except the operator's hand gripping the invention is employed to function as ratcheting mechanism 52. Since surface 160 of handle 130 is generally round and smooth as described above, it is capable of spinning within the operators fingers during continuous rotation when a loose grip is applied to handle 130. Also, the operator's palm can firmly press against knob 155 along axis 24 towards working end 12 to provide a good connection or coupling with the fastener. During rotation, knob 155 and the operators loose gripped fingers glide in section 160 as they travel in a counter-clockwise rotation during the clockwise rotations with respect to tool 150's end 16 with axis 26. This operation allows rapid rotation of tool 150 to continuously drive rotary fasteners in the manner described above.

In high torque situations when the operator can not apply enough rotational torque on tool 150 to maintain smooth continuous rotation as described, they simply change to a tight grip on handle 130, and introduce twisting of the wrist on end 16, and the tool functions by allowing the operator to apply rotational torque to end 12, similar in the function shown in FIG. 19. As described, this is possible due to the mechanical couple the operator is producing at end 16 on drive tool 150 that tends to rotate it about its axis 24.

Ramifications

Although the description above contains many specificities, these should not be construed as limiting the scope of the invention, but as merely providing illustrations of some of the presently preferred embodiments of the rotary driver. For example:

The invention could also be made having knuckles or joints in the shanks or adaptors that allow the invention to be placed in the condition for continuous rotation as described. These joints can be designed with limited, specific rotations, and further be detented with ball plungers or similar methods to adequately lock the invention in position. For example, this allows for a ratcheting screwdriver to have a traditional straight shank for normal function, and allows conversion to continuous rotation as described above by actuating the joints to a shape the tool as describe above, having an axis angle 30.

It has been shown that the shape of the invention can be varied substantially and still retain described function. It is also known that the rotation of the tool can be derived from the operator's forearm and elbow, allowing the tool to function as described, without the need to rotate at the wrist. This also allows the comfortable range for wrist rotation as described to be expanded if required. It is also known that due to the slip fit of the drive shanks into the holders or bit receptacles, some tilting of the bit with respect to the shank can occur. It is respected that designers can allow for some compensation of the described angles of bit 10 and driver 54.

It is understood that the invention can be produced to comply with all applicable ANSI and Industry Standards; allowing invention to be used with similar designed tooling and fasteners, and be interchangeable with traditional insert bits. It is also known that the invention is useful on many different styles of working tips or drive ends that require rotation to function, such as hex drive drill bits, reamers, and square drive bits.

It is also understood that a ratchet is defined as a mechanism that consists of a wheel having inclined teeth into which a pawl engages so that motion can be imparted to the wheel, governed, or prevented, used in hand tools (as a wrench or screwdriver), to allow effective motion in one direction only; as described by Webster's dictionary. It is understood that many complex ratchet designs exist, some using multiple pawls to switch direction, to meet this definition. It is therefore concluded that the specific design of a ratchet mechanism used in conjunction with the invention as described, will not change its function. It is also presented that the invention functions to produce work in either position of the ratchet mechanism, resulting in an efficient driving tool.

Thus it is to be understood that various modifications can be made without departing from the spirit or scope of this invention as defined in the claims appended hereto.

I claim:

1. An insert bit designed to drive threaded fasteners, having the drive shank and working tip on different axes, whereby a couple applied to said shank is transferred to said working tip.

2. The bit in claim 1, wherein a force applied to said shank creates a torque at said working end.

3. The bit in claim 2, wherein said axes cross or intersect each other at a point behind said tip, forming an angle of about 0 to 15 degrees, whereby said angle is in a comfortable range for rotation of an operators wrist.

4. The bit described in claim 3, wherein the preferred value of said angle is about 6 degrees.

5. The bit in claim 3, wherein said tip is a square drive, whereby said bit can accept square drive tools to drive threaded fasteners.

6. The bit in claim 5, wherein said shank is a square drive, whereby said bit can be installed into square drive tools.

7. The bit in claim 2, wherein said drive end is made from round stock, whereby said end can slip into insert bit holders, allowing concentric rotation within, disallowing said transfer.

8. The bit in claim 3, wherein said working tip is a insert bit holder to retain conventional insert bits.

9. The bit in claim 8, wherein said shank is a square drive, whereby said bit is transformed into a shank that can be installed into square drive tools.

10. The bit in claim 8, wherein said drive shank is incorporated into a ratchet wheel, having a switchable pawl to selectively prevent rotation in either direction, whereby a clockwise or counterclockwise couple applied to said shank can be transferred to said working tip, allowing free rotation in the opposite direction.

11. The bit in claim 10, wherein said shank contains a clearance pocket with adequate depth for a screwdriver tip, having a form designed to engage the blade(s) of said screwdriver, allowing the screwdriver to rotate said wheel.

12. The bit in claim 10, wherein said shank contains a gripable handle, whereby said bit is transformed into a rotary bit driving tool.

13. The bit in claim 3, wherein a middle section connects said shank and tip, said middle section formed away from the tip at an angle, extending at an adequate distance to create a lever arm in which to apply turning torque at the tip, formed back towards the working axis at an angle to said drive end, creating said axes angle, whereby the bit can be formed from a length of material.

14. The bit in claim 13, wherein said working end is a Phillips tip.

15. The bit in claim 13, wherein said working end is a ball hex tip.

16. The bit in claim 13, wherein said working end is a Torx tip.

17. The bit in claim 13, wherein said working end is a slotted tip.

18. The bit described in claim 3, installed into a ratcheting insert bit driving screwdriver forms a rotary driver, providing the operator both continuous rotation and normal ratcheting operation of said driver, having seamless transition from each use, whereby the driver can be used efficiently to drive rotary fasteners in continuous rotation, and retain normal ratcheting operation of said tool.

19. The driver in claim 18, wherein said continuous rotation is produced by the operator applying force directed towards fastener with a hand gripping the driver's handle, concurrently rotating the driver about said working axis in a desired driving direction, sweeping a cone shape with said drive axis about the working axis, having the ratcheting mechanism allow opposite rotation of said handle with respect to the driver's shank, allowing the handle to keep its orientation within the operators hand during said rotation, whereby the operator can rotate the driver continuously to drive a fastener with a single grip on the handle.

20. The driver in claim 19, wherein said normal operation is produced by the operator twisting the handle in said direction, the ratcheting mechanism preventing handle rotation with respect to the shank in said direction, allowing the screwdriver to produce a mechanical couple on said drive end of said bit, which provides the turning torque to rotate the bit about the working axis, whereby tightening torque is applied to the fastener with only twisting of the wrist on said driver, allowing said driver to operation similar to the operation of said screwdriver.

21. The driver in 20 wherein said twisting and rotational torques combined on the invention produce higher torque levels on said fastener, whereby the operator can apply more turning power over conventional insert bits.

22. A rotary tool designed to drive threaded fasteners, comprising a working end with axis formed to engage said fasteners, a rigid drive handle end with axis located at a radial distance from said working axis, a middle section connecting said ends, said axes crossing or intersecting each other at a point behind said working end, whereby said tool can drive a fastener by rotating it about said fastener's axis with a hand on said handle end.

23. The tool described in claim 22, wherein said axes form an angle of about 1 to 15 degrees, whereby said angle is in a comfortable range for rotation of an operators wrist.

24. The tool described in claim 23, wherein the preferred value of said angle is about 6 degrees.

25. The tool in claim 23, wherein said working end is a square drive, whereby said tool can drive sockets.

26. The tool in claim 23, wherein said working end is a bit holder to retain insert bits.

27. The tool in claim 23, wherein said middle section is bent away from said working end at an angle, extending at an adequate distance to create a lever arm in which to apply turning torque at the working end, bent back towards the working axis at an angle to said drive end, creating said axes angle, whereby the tool can be formed from a length of material.

28. The tool in claim 23, wherein said handle is tapered to further comfort user.

29. The tool in claim 23, wherein said handle diameter ranges from about ¼-2 inches, to fit into a user's grip.

30. The tool in claim 23, wherein said handle contains a larger diameter portion to allow the user's grip to apply force towards the working end.

31. The tool in claim 23, wherein said handle contains a free spinning knob rotatably mounted to its end.

32. The tool in claim 23, wherein said handle contains at least one free spinning handle portion, whereby said tool can be rotated continuously about said fastener's axis by gripping said spinning handle, retaining a portion of the rigid handle for applying twisting torque on said handle.

33. The tool described in claim 23, wherein said drive end has a free spinning handle rotatably mounted, a rigid, gripable surface in front of said handle, positioned to allow easy access from said handle, whereby said tool can be rotated continuously about said fastener's axis by gripping the handle, said surface providing a place to apply twisting torque on the tool for high torque applications.

34. The tool in claim 33, wherein said surface is a rigid, gripable handle.

35. A ratcheting screwdriver employed to drive threaded fasteners, having a design to produce work in either position of the ratchet mechanism, whereby said screwdriver can efficiently drive fasteners.

36. The screwdriver in claim 35, wherein said fasteners are driven in continuous rotation while ratcheting the pawl of said mechanism.

37. The screwdriver in claim 36, having a shaft and handle, said shaft having a bit holder at its working end designed to retain insert bits for engagement with threaded fasteners, said end having a driving axis; a ratcheting handle mounted at its other end, having an axis of rotation located at a radial distance from said driving axis, said handle having a switchable pawl to selectively prevent rotation in either direction about said axis, a middle section connecting said ends, said axes crossing or intersecting each other at a point behind said working end, forming an angle of about 1 to 15 degrees, whereby said screwdriver can be rotated in a desired driving direction about a fastener in continuous rotation, sweeping a cone shape with said handle axis about said driving axis, said ratcheting handle rotation opposite with respect to said shaft, allowing the handle to keep its orientation within the operators hand during said desired rotation.

38. The screwdriver in claim 37, wherein a twist on the handle in said desired direction transmits torque to said working end, whereby said tool behaves like a conventional ratcheting screwdriver.

39. The screwdriver in claim 38, wherein said axes angle is about 6 degrees.

40. The screwdriver in claim 38, wherein said shaft is removable from said handle.

41. The screwdriver in claim 37, wherein said working end is formed or machined to directly engage said fasteners.

42. The screwdriver in claim 37, wherein said working end is a square drive for driving sockets.

43. The screwdriver in claim 38, wherein said angle is formed by actuating jointed portions of said shaft, to shape for said rotation, whereby said shaft can be straightened for normal function.

44. A insert bit design allowing the ratcheting mechanism of a bit driver's handle rotate in an opposite direction of desired driver rotation, whereby said screwdriver can be rotated about a fastener in continuous rotation.

45. A bit holder design, having a main body, said body having a bit holder working end at one end designed to retain insert bits for engagement with threaded fasteners, said end having a driving axis; a bottomed hole at its other end, having an axis located at a radial distance from said driving axis, said axes crossing or intersecting each other at a point behind said working end, forming an angle of about 1 to 15 degrees, said hole having clearance for a screwdriver shank allowing concentric rotation within, whereby said screwdriver can be rotated in a desired driving direction about said fasteners in continuous rotation, sweeping a cone shape with said screwdriver about said driving axis, said screwdriver rotation opposite with respect to said holder, allowing the handle to keep its orientation within the operators hand during said desired rotation.
